(19) United States
(12) Patent Application Publication
(10) Pub. No.: US 2014/0017404 A1
(43) Pub. Date: Jan. 16, 2014

(54) PATTERN-PRINTING DEVICE

(71) Applicants: Taik Min Lee, Daejeon (KR); In Young Kim, Daejeon (KR); Seung-Hyun Lee, Daejeon (KR); Jeong Dai Jo, Daejeon (KR); Dong-Soo Kim, Daejeon (KR)

(72) Inventors: Taik Min Lee, Daejeon (KR); In Young Kim, Daejeon (KR); Seung-Hyun Lee, Daejeon (KR); Jeong Dai Jo, Daejeon (KR); Dong-Soo Kim, Daejeon (KR)

(73) Assignee: KOREA INSTITUTE OF MACHINERY & MATERIALS, Daejeon (KR)

(21) Appl. No.: 13/885,764

(22) PCT Filed: Apr. 4, 2012
(86) PCT No.: PCT/KR2012/002543

§ 371 Date: May 16, 2013

(30) Foreign Application Priority Data
Apr. 4, 2011 (KR) 10-2011-0030658

(51) Int. Cl. B41M 3/00

(52) U.S. Cl. CPC B41M 3/00
USPC 427/256; 118/102

(57) ABSTRACT

The present invention relates to a device for patterning a substrate, and it particularly relates to a pattern printing device for performing a patterning operation by a simple process and requiring no cleansing of a plate by patterning a functional ink on the substrate by using a pattern roller on which a printing pattern is formed when the functional ink is coated is applied to a base of a PDMS material.

### TECHNICAL FIELD

The present invention relates to a device for patterning a substrate, and it particularly relates to a pattern printing device for performing a patterning operation by a simple process and requiring no cleansing of a plate by patterning a functional ink on the substrate by using a pattern roller on which a printing pattern is formed when the functional ink is coated to a base of a PDMS material.

### BACKGROUND ART

In general, a printed electronics part is an electronic element formed by a printing process, and the printed electronics part includes an RFID tag, a PCB electrode, and an electronic element having a conductive electrode of an electromagnetic wave shielding film.

A method for forming a pattern of the printed electronics includes patterning a conductive electrode according to a printing method, and hardening the same by using heat to generate the pattern.

Various printing methods for printing fine patterns have been developed according to the printed electronics being down-sized and highly integrated.

A reverse offset printing method has been proposed as one of the printing methods.

The reverse offset printing method includes coating ink on a roller by using a slit coater, setting an unneeded portion to a cliché to peel it off, and setting the ink remaining on the roller to the substrate.

The reverse offset printing method has a merit of realizing a fine pattern with a size of several microns since it directly sets the ink to the substrate from the roller and uses a low set pressure.

However, regarding the reverse offset printing method, viscosity of the ink must be very low (below 5 cp) in the case of coating using a slit coater, and it must be very high (greater than several thousand cp) on the cliché and the substrate so the ink of which the viscosity is variable when the printing process is progressed must be used. The ink is a compound of a solvent with high or low volatility, it is very difficult to develop the ink, and it is not easy to control a final printing thickness.

To solve the drawback, a method for forming an ink by performing the spin coating process, and forming a printing pattern through a cliché, has been used.

The above-noted method is disclosed by Korean Patent No. 975094, and will now be described with reference to FIG. 1 to FIG. 3.

As shown in FIG. 1, a roller 110 of a conventional printing device is configured to be rolled on a spin coating unit 120 and a cliché 130.

A roller driver is connected to the roller 110, and the roller 110 is configured to move in a horizontal direction or a vertical direction according to an operation of the roller driver and contacts the spin coating unit 120 and the cliché 130 and rolls thereon.

The roller 110 includes a roll frame 111, and a blanket 112 for wrapping the roll frame 111 and providing an ink coated side according as the roll frame 111 is rotated.

The roll frame 111 is made of a metal material, and the blanket 112 is made of an elastic material such as silicon or rubber.

The spin coating unit 120 supplies ink to the roller 110 so that the ink may be coated on the roller 110, and it forms an ink film with a constant thickness through the spin coating process.

When the ink coated roller 110 is rolled, the cliché 130 peels off an unneeded portion of the ink coated on the roller 110 to the cliché 130.

A printing method using a conventional pattern printing device will now be described with reference to FIG. 2 and FIG. 3.

As shown in FIG. 2, an ink film with a constant thickness is formed through spin coating.

As shown in FIG. 3 (a), the roller 110 is rolled on the ink film to coat the ink on the roller 110.

As shown in FIG. 3 (b), the roller 110 is rolled on the cliché 130 to discard the ink to the cliché 130.

As shown in FIG. 3 (c), the roller 110 is rolled on the substrate 140 to set the ink on the substrate 140 and thereby form a print pattern.

The conventional patterning device to pattern method has the following problems.

First, the process has multiple stages so the process is complex and it is difficult to install the device.

That is, the conventional patterning method includes performing a spin coating process, performing the ink discarding process, and performing the ink setting process.

Second, the conventional patterning method has a difficulty in always cleansing the plate such as the cliché, and particularly, fine patterns require increased processing difficulty.

### DISCLOSURE

### Technical Problem

The present invention has been made in an effort to provide a pattern printing device for performing a patterning process according to a simple process and requiring no cleansing on a plate by applying a functional ink to a base made of a polydimethylsiloxane (PDMS) material, and patterning the functional ink on the substrate by using a pattern roller on which a print pattern is formed.

### Technical Solution

An exemplary embodiment of the present invention provides a pattern printing device including: a base made of a PDMS material on which a functional ink is applied; and a pattern roller including a roller driven by a roller driver, and a pattern blanket which is attached to the roller and on which a print pattern is formed, wherein the functional ink is set to a substrate through the pattern blanket.

The pattern blanket is made of a PDMS material, and a contact force of the PDMS material of the pattern blanket is greater than a contact force of the PDMS material of the base.

The pattern printing device further includes: an ink applier installed in the base and applying the functional ink to the base; a base transferrer for taking and transferring the base; a first stage disposed at a first side of the ink applier and receiving the base transferred by the base transferrer; and a second stage disposed at a first side of the first stage and receiving the substrate.

The pattern blanket is made of a PDMS material.

The pattern printing device further includes: an ink applier installed in the base and applying the functional ink to the base; a second stage disposed at a first side of the ink applier and receiving the substrate; and a moving unit for moving the ink applier and the second stage.

The moving unit includes: a ball screw rotated by a rotation means; connectors combined to the ball screw, transferred by rotation of the ball screw, and connected to the ink applier and the second stage; and a housing for receiving the ball screw and the connectors.

Another embodiment of the present invention provides a pattern printing method for patterning a substrate by using the pattern printing device, including: applying a functional ink to a base made of a PDMS material by using a spin coating method or a slit coating method; contacting the pattern roller to the base to set the functional ink to the pattern roller; and contacting the pattern roller to the substrate to set the functional ink that is set to the pattern blanket to the substrate.

The contacting of the pattern roller to the base to set the functional ink to the pattern roller includes: taking the base to which the functional ink is applied, and transferring and loading the base to a first stage disposed at a first side of the base; and driving the pattern roller on the base loaded to the first stage to set the functional ink to a pattern blanket of the pattern roller.

The contacting of the pattern roller to the base to set the functional ink to the pattern roller includes: transferring the base to which the functional ink is applied to the pattern roller; and driving the pattern roller on the base to set the functional ink to a pattern blanket of the pattern roller.

The pattern printing method further includes transferring the second stage on which the substrate is loaded to the pattern roller to set the functional ink that is set to the pattern roller to the substrate.

The pattern printing method further includes cleansing the base.

### ADVANTAGEOUS EFFECTS

According to the embodiments of the present invention, the patterning process is possible by a simpler process and the plate such as the cliché is not used to omit the process for cleansing the plate, thereby improving job efficiency.

### DESCRIPTION OF DRAWINGS

FIG. 1 to FIG. 3 show schematic views of a conventional patterning device and method.

FIG. 4 to FIG. 6 show schematic views of a patterning device and method according to an exemplary embodiment of the present invention.

FIG. 7 shows a photograph of a pattern that is patterned by a patterning device and method according to an exemplary embodiment of the present invention.

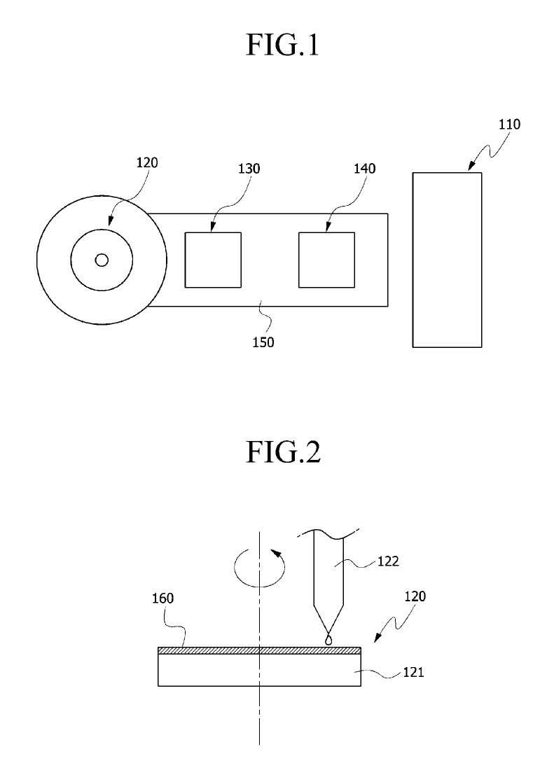

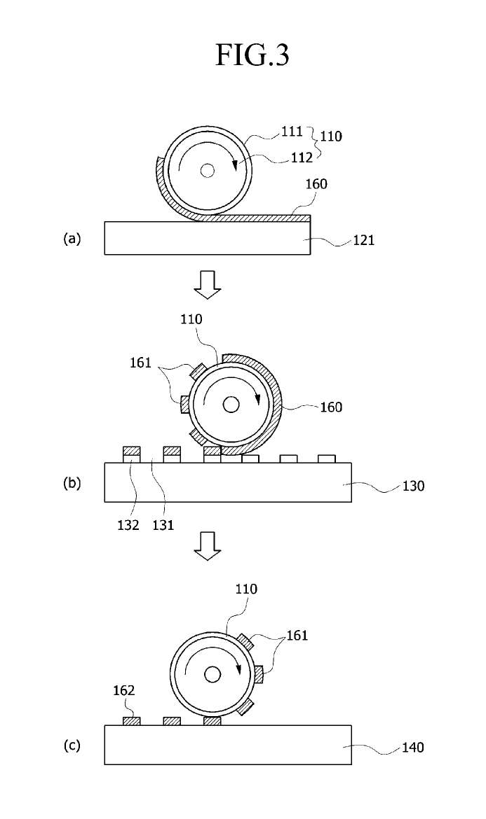

### MODE FOR INVENTION

Before explaining the current examples of the present invention in detail, it is to be understood that the invention is not limited in its application to the details of construction and arrangements of the components set forth in the following description or illustration.

The invention is capable of other examples and of being practiced and carried out in various ways.

Also, it is to be understood that phraseology and terminology used herein with reference to device or element orientation (such as, for example, terms like “front”, “back”, “up”, “down”, “top”, “bottom”, “left”, “lateral”, and the like) are only used to simplify description of the present invention, and do not alone indicate or imply that the device or element referred to must have a particular orientation.

Prior to making the description, it is to be understood that the terms or words used in the specification and claims of the present invention are not to be interpreted only using typical or dictionary limited meanings, and are constructed as meanings and concepts conforming to the technical spirit of the present invention based on the principle that the inventors can appropriately define the concepts of the terms to explain the present invention in the best manner.

Accordingly, it is to be understood that the detailed description, which will be disclosed along with the accompanying drawings, is intended to describe the exemplary embodiments of the present invention and is not intended to represent all technical ideas of the present invention. Therefore, it should be understood that various equivalents and modifications can exist which can replace the embodiments described in the time of the application.

Embodiments of the present invention will now be described with reference to accompanying drawings.

### Exemplary Embodiment 1

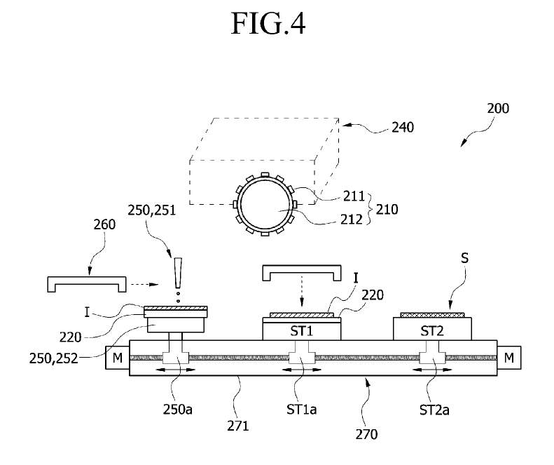

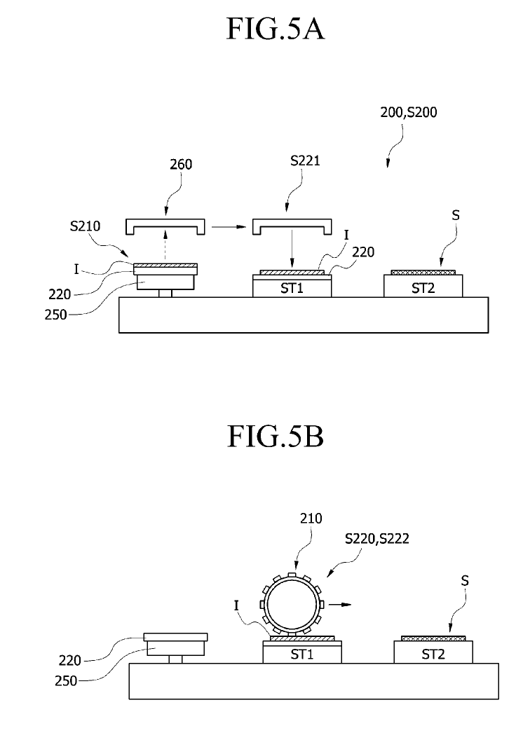

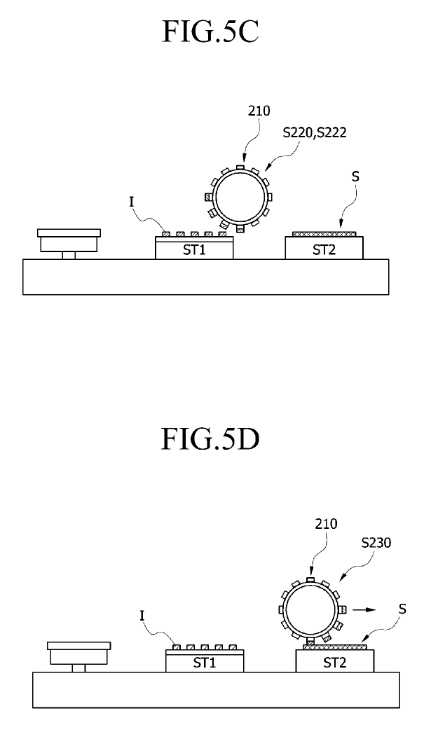

As shown in FIG. 4, a printing device 200 according to a first embodiment of the present invention includes a base 220 made of a PDMS material on which a functional ink (I) is applied, and a pattern roller 210.

The pattern roller 210 includes a roller 212 driven by a roller driver 240, and a pattern blanket 211 which is attached to the roller 212 and on which a print pattern is formed.

The roller driver 240 is known to a person skilled in the art (e.g., Korean Patent No. 975994 that is previously described), and no detailed description and illustration will be provided.

That is, according to the embodiment of the present invention, the pattern roller 210 on which the pattern to be printed is formed contacts the functional ink that is applied to the base 220 of the PDMS material so that the functional ink is set and is finally patterned on the substrate (S).

Prior art required the peeling-off process twice to set the functional ink on the substrate.

However, the embodiment of the present invention patterns the substrate (S) by performing the peeling-off process once thereby simplifying the job process.

Particularly, as described, the base 220 is made with the PDMS material to set the entire functional ink applied to the base 220 to the pattern roller 210

When the functional ink (I) is coated on the base 220, the base 220 has a low contact force with the functional ink (I).

That is, when the pattern blanket 211 takes a pattern, that is, when the pattern blanket 211 contacts the base 220 to bring a portion of the functional ink (I), the portion (in which the pattern blanket contacts the base) includes the entire functional ink (I).

Also, an entire portion (that does not contact the pattern blanket) remaining on the base 220 remains thereon.

An ink coated thickness on the base 220 is the final printing thickness, so a constant thickness is uniformly printed by controlling the coating thickness.

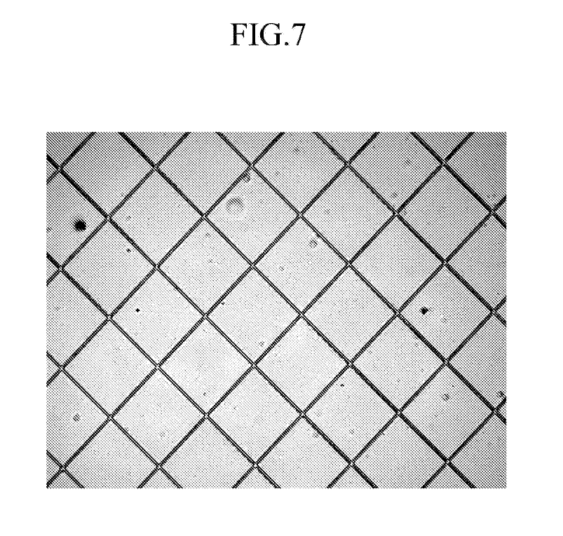

Also, in the case of bringing the entire pattern (formed with the functional ink that is entirely set to the pattern blanket), a cross-sectional shape of the printed side becomes flat and printing quality becomes excellent (refer to FIG. 7.)

When the ink is coated on the base made of a glass substrate material and the pattern blanket brings the pattern, half the pattern is set to the pattern blanket and another half of the pattern remains on the glass substrate to deteriorate printing quality.

In this instance, the pattern blanket 211 of the pattern roller 210 can be made of the PDMS material, and the contact force of the PDMS material of the pattern blanket 211 is greater than the contact force of the PDMS material of the base 220 which is advantageous for the functional ink (I) to be entirely set.

In this instance, the PDMS stands for polydimethylsiloxane.

The ink is applied to the base 220, and in order to set it to the pattern blanket 211, it is desirable for the contact force of the blanket 211 to be greater than the contact force of the base 220 as described above.

The contact force is controlled by controlling an amount of a hardener or controlling an additive.

For example, when a PDMS blanket is made, a hardener Sylgard 184B is input to the Sylgard 184A, and the contact force is increased by increasing the ratio of the Sylgard 184B.

For another example, the contact force can be increased by applying a surface treatment such as a primer process, a plasma process, or a UV process on the blanket surface.

As described, the entire functional ink (I) is set to the blanket 211 by increasing the contact force of the PDMS material of the blanket 211 to be greater than the contact force of the PDMS material of the base 220.

When the base 220 contacts the pattern roller 210, it is possible to take the base 220 and move the same (to be described in a second exemplary embodiment), or it is possible to transfer a portion on which the base 220 is provided (to be described in a third exemplary embodiment).

The respective exemplary embodiments will now be described.

### Exemplary Embodiment 2

As shown in FIG. 4, a printing device 200 according to a second embodiment of the present invention further includes: an ink applier 250 installed in the base 220 and applying the functional ink (I) to the base 220; a base transferrer 260 for taking the base 220 and transferring the same; a first stage ST1 disposed at a first side of the ink applier 250 and receiving the base 220 transferred by the base transferrer 260; and a second stage ST2 disposed at a first side of the first stage ST1 and receiving the substrate (S).

The ink applier 250 applies the functional ink to the base 220, and for example, a spin coating device or slit coating device is usable.

In this instance, the ink applier 250 may include an ink dispenser 251 for outputting the ink, and a base support 252 disposed on a bottom of the base 220.

When the ink applier 250 is a spin coating device, the base support 252 is used as a rotated device.

When the ink applier 250 is a slit coating device, the ink dispenser 251 can be a slit for applying the ink.

Here, the ink applier 250 aims at applying the functional ink to the base 220 as described above, so when the ink applier 250 achieving this purpose uses other methods differing from the above-described method, it naturally covers the scope of the present invention.

The base transferrer 260 takes the base 220 and transfers the same.

In FIG. 4, the base transferrer 260 has a clamp shape and transfers the base 220.

In this instance, the described configuration for taking a specific object and transferring it is known to a skilled person in the art (e.g., U.S. Pat. No. 7,792,608 and U.S. Patent Laid-Open Publication No. 2007/0294883).

The base transferrer 260 aims at taking the base 220 and transferring the same, so when the base transferrer 260 achieving this purpose uses other methods differing from the above-described method, it naturally covers the scope of the present invention.

When the base 220 is transferred to the pattern roller 210 by the base transferrer 260, the functional ink applied to the base 220 is set to the pattern roller 210.

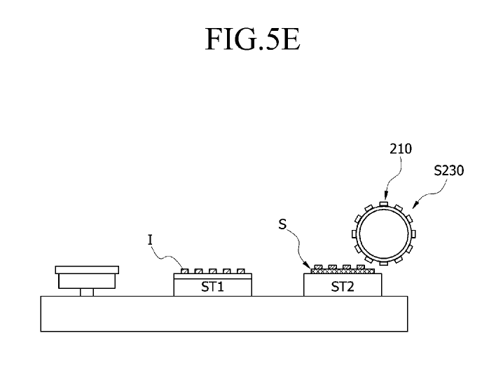

A method (S200) for printing a pattern by using the pattern printing device 200 will now be described with reference to FIG. 5A to FIG. 5E.

The functional ink (I) is applied to base 220 made of the PDMS material by using the spin coating method or the slit coating method (S210) as shown in FIG. 5A).

In the S210, the spin coating method or the slit coating method can be performed by the ink applier 250.

The pattern roller 210 contacts the base 220 to set functional ink (I) to the pattern roller 120 (S220) as shown in FIG. 5B and FIG. 5C.

In this instance, in S220, the conductive ink (I) is set to the pattern blanket 211 of the pattern roller 210, so the conventional configuration of the cliché can be omitted.

The pattern roller 210 contacts the substrate (S) to set the functional ink (I) that is set to the pattern blanket 211 to the substrate (S) (S230) as shown in FIG. 5D and FIG. 5E.

In this instance, the base 220 is taken and transferred to the pattern roller 210 to allow the pattern roller 210 to contact the base 220.

That is, S220 may include: taking the base 220 to which the functional ink (I) is applied, transferring the base 220 to a first stage ST1 disposed to a first side of the base 220, and loading the base 220 thereon (S221) as shown in FIG. 5A; and driving the pattern roller 120 on the base 220 loaded to the first stage ST1 to set the functional ink (I) to the pattern blanket 211 of the pattern roller 210 (S222) as shown in FIG. 5B and FIG. 5C.

The pattern roller 210 is moved to the substrate (S) to perform the step S230.

In this instance, the pattern roller 210 may be moved to the substrate (S) by the roller driver 240.

In addition, the substrate (S) can be transferred to the pattern roller 210 by a moving unit 270 to be described.

A not-shown stage (S240) for cleansing the base 220 can be further included, which is similarly applied to the subsequent exemplary embodiment and no repeated description will be provided.

### Exemplary Embodiment 3

As shown in FIG. 4, the device 200 includes: an ink applier 250; an ink applier 250 installed in the base 220 and applying the functional ink (I) to the base 220; a second stage ST2 disposed at a first side of the ink applier 250 and receiving the substrate (S); and a moving unit 270 for moving the ink applier 250 and the second stage ST2, and it can move the ink applier 250 or the second stage ST2.

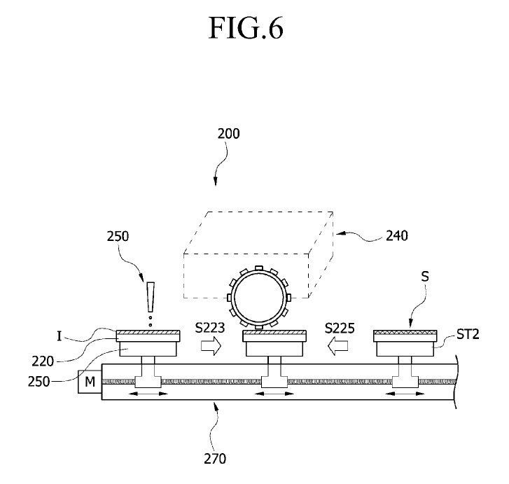

That is, the base 220 has been taken and transferred by the base transferrer 260 in the second exemplary embodiment 2, and the base 220 is moved to contact the pattern roller 210 (refer to FIG. 6) in the third exemplary embodiment.

The moving unit 270 includes: a ball screw 272 rotated by a rotation means (M); connectors 250a and ST2a combined to the ball screw 272 and transferred by rotation of the ball screw 272 and connected to the ink applier 250 and the second stage ST2; and a housing 271 for receiving the ball screw 272 and the connectors 250a and ST2a.

That is, when the ball screw 272 is rotated by a rotation means (M) such as a motor, a connector combined to the ball screw 272, for example, the connector 250a combined to the ink applier 250, is transferred.

The ink applier 250 may include an ink dispenser 251 for coating the ink, and a base support 252 for supporting the base 220.

In this instance, the connector 250a of the ink applier 250 can be combined to the base support 252.

Therefore, the connector 250a combined to the base support 252 is transferred to move the base 220 by the moving unit 270.

The connector (ST2a) combined to the second stage ST2 is also transferrable. As described, while the pattern roller 210 is stopped, the second stage ST2 on which the ink applier 250 or the substrate (S) is loaded is transferred and the pattern roller 210 contacts a conductive ink (I).

The connectors 250a and ST2a are shown in FIG. 4 to be combined to the single ball screw 272, and the connectors 250a and ST2a can be combined to separated ball screws and be independently transferred.

Further, as shown in FIG. 4, a connector ST1a is installed in the first stage ST1 so that it may be combined to the ball screw 272.

A printing method S200 by the printing device 200 will now be described.

In the printing method S200, the S210 and S230 correspond to those of the second exemplary embodiment, so the S220 will be described.

The S220 includes: transferring the base 220 to which the functional ink (I) is applied to the pattern roller 210 (S223) as shown in FIG. 6; and driving the pattern roller 210 on the base 220 and setting the functional ink (I) to the pattern blanket 211 of the pattern roller 210 (S224).

That is, in S223, the base 220 is transferred when the connector 250a of the ink applier 250 is transferred to the pattern roller 210 by the moving unit 270.

In S224, as described above, the pattern roller 210 is driven on the base 220 to set the functional ink (I) to the pattern blanket 211 of the pattern roller 210, which corresponds to the second exemplary embodiment and will not be described.

The second stage ST2 on which the substrate (S) is loaded is transferred to the pattern roller 210 to set the functional ink (I) that is set to the pattern roller 210 to the substrate (S) (S225) after S224.

In this instance, the second stage ST2 is movable to the pattern roller 210 by the moving unit 270.

The S230 can be performed when the pattern roller 210 is moved to the substrate (S) by the roller driver 240 after the S224.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A pattern printing device comprising:
a base made of a PDMS material on which a functional ink is applied; and
a pattern roller including a roller driven by a roller driver, and a pattern blanket which is attached to the roller and on which a print pattern is formed,
wherein the functional ink is set to a substrate through the pattern blanket.

2. The pattern printing device of claim 1, wherein
the pattern blanket is made of a PDMS material, and a contact force of the PDMS material of the pattern blanket is greater than a contact force of the PDMS material of the base.

3. The pattern printing device of claim 1, further comprising:
an ink applier installed in the base and applying the functional ink to the base;
a base transferrer for taking and transferring the base;
a first stage disposed at a first side of the ink applier and receiving the base transferred by the base transferrer; and
a second stage disposed at a first side of the first stage and receiving the substrate.

4. The pattern printing device of claim 1, further comprising:
an ink applier installed in the base and applying the functional ink to the base;
a second stage disposed at a first side of the ink applier and receiving the substrate; and
a moving unit for moving the ink applier and the second stage.

5. The pattern printing device of claim 4, wherein
the moving unit includes:
a ball screw rotated by a rotation means;
connectors combined to the ball screw, transferred by rotation of the ball screw, and connected to the ink applier and the second stage; and
a housing for receiving the ball screw and the connectors.

6. A pattern printing method for patterning a substrate by using the pattern printing device disclosed by claim 1, comprising:
applying a functional ink to a base made of the PDMS material by using a spin coating method or a slit coating method;
contacting the pattern roller to the base to set the functional ink to the pattern roller; and
contacting the pattern roller to the substrate to set the functional ink that is set to the pattern blanket to the substrate.

7. The pattern printing method of claim 6, wherein
the contacting of the pattern roller to the base to set the functional ink to the pattern roller includes:
taking the base to which the functional ink is applied, and transferring and loading the base to a first stage disposed at a first side of the base; and
driving the pattern roller on the base loaded to the first stage to set the functional ink to a pattern blanket of the pattern roller.

8. The pattern printing method of claim 6, wherein
the contacting of the pattern roller to the base to set the functional ink to the pattern roller includes:
transferring the base to which the functional ink is applied to the pattern roller; and
driving the pattern roller on the base to set the functional ink to a pattern blanket of the pattern roller.

9. The pattern printing method of claim 8, further including
transferring the second stage on which the substrate is loaded to the pattern roller to set the functional ink that is set to the pattern roller to the substrate.

10. The pattern printing method of claim 6, further including
cleansing the base.
